(19) United States
(12) Patent Application Publication
(10) Pub. No.: US 2005/0234155 A1
(43) Pub. Date: Oct. 20, 2005

(54) Method for improving mechanical properties of PVC-wood and other natural fiber composites using PVC stabilizers

(76) Inventors: Radu Bacaloglu, Hamburg, NY (US); Phillip Kleinlauth, West Milford, NJ (US); Peter Frenkel, Danbury, CT (US); Perry M. Reed, Matawan, NJ (US); Charles E. Coursen, Prospect Park, NJ (US)

Correspondence Address: Michael P. Dilworth;CROMPTON CORPORATION, Benson Road, Middlebury, CT, 06749, US

(21) Appl. No.: 10/827,823

(22) Filed: Apr. 20, 2004

(51) Int. Cl. C08J 3/00

(52) U.S. Cl. 524/17

(57) ABSTRACT

Disclosed herein is a process for improving mechanical and chemical properties of a composite of poly(vinyl chloride) and at least one natural fiber comprising adding to said composite at least one heat stabilizer selected from the group consisting of: A) alkyltin reverse esters-sulfides; B) alkyltin alkyl maleates; and C) complex mixtures of calcium and/or zinc carboxylates/acetylacetonates.

### BACKGROUND OF THE INVENTION

1. Field of the Invention

This invention relates to the field of additives, and, more specifically, to heat stabilizers for poly(vinyl chloride)-wood composites used as construction materials for decking, railing, window lineals, roofing shingles, fencing, siding, furniture, and the like.

2. Description of Related Art

Wood-poly(vinyl chloride) (PVC) composites are materials that look like wood and are used on a large scale in the building industry because of their low-cost maintenance and resistance to biological, and thermal degradation. Being a component of the composite material, wood is known to affect negatively mechanical properties, such as tensile strength, impact strength, or flexural strength. These properties can be improved by assuring good adhesion of the PVC to the wood particles by preventing the thermal degradation of the PVC.

Attempts to improve the adhesion of PVC to wood particles have been directed primarily to the use of compatibilizers, such as those listed in the following groups:

Unsaturated, epoxy, amino, thio-alkyl trialkoxysilanes:
U.K. Patent Application GB 2 192 397 A;
Kotka, B. V., et al., J. Vinyl Technol. 12:146-153 (1990);
Matuana, L. M., et al., Polymer Composites 19:446-455 (1998);
Rodriguez-Fernandez, O. S., et al., Proceedings ANTEC 2002 (2002).

Isocyanates and polymeric isocyanates:
U.K. Patent Application GB 2 192 398 A;
Maldas, D., et al., J. Reinforced Plastics and Composites 8:2 (1990);
U.S. Pat. No. 6,248,813.

Carboxylic acids, anhydrides and polymeric anhydrides:
Matuana, L. M., et al., Polymer Composites 19:446-455 (1998);

Carboxylic acids:
Kotka, B. V., et al. Polymer Composites 11:84-89 (1990).
U.S. Pat. No. 6,210,792.

Chlorinated polyethylene and polyvinyl chloride copolymers:
Guffey, V. O., et al., Proceedings ANTEC 2002 (2002).
European application No. 0046579

Phenol-, melamine-, urea-formaldehyde resins:
Natow, M. et al., Plaste und Kautschuk 29:277-278 (1982);
Canadian Patent No. 763,000;
U.S. Pat. No. 4,594,372.

Acrylonitrile, methacrylates, vinyl acetate, acrylicimide, styrene and acrylamide polymers and copolymers:
U.S. Pat. No. 6,210,792;
U.S. Pat. No. 5,981,067.

This approach requires relatively expensive additives and complex processes for coating the wood particles.

The following types of stabilizers are listed in the literature for use in PVC-wood composites:

Organotin thioglycolates and laurates:
U.S. Pat. No. 5,981,067
U.S. Pat. No. 6,015,612;
U.S. Pat. No. 6,210,792;
Joo, Y. L., et al., Proceedings Intern. Polymer Processing XIV: 10-20 (1999);
Mengeloglu, F., et al., J. Vinyl & Additive Technol. 6:153-157 (2000).

Tribasic lead sulfate, lead stearate:
U.S. Pat. No. 4,594,372
French Patent No. 2 514 773;
European Patent Application No. 0 284 058 A2;
Rusu, M., et al., Industria Usoara 30:504-508 (1983).

Barium acetate:
Kotka, B. V., et al, J. Vinyl Technol. 12:146-153 (1990);
Kotka, B. V., et al. Polymer Composites 11:84-89 (1990).

U.S. Pat. No. 5,981,067 relates to a composite pellet comprising a thermoplastic polymer and wood fiber composite that can be used in the form of a linear extrudate or thermoplastic pellet to manufacture structural members. The fiber can be modified to increase compatibility. The polymer and wood fiber composite may contain an intentional recycle of a waste stream which can comprise adhesive, paint, preservative, or other chemical waste stream common in the wood-window or door manufacturing process. The initial mixing step before extrusion of the composite material insures substantial mixing and melt contact between molten polymer and wood fiber. The extruded pellet is said to comprise a consistent proportion of polymer, wood fiber and water.

U.S. Pat. No. 6,280,667 discloses polymer/wood fiber composite structural members that can be manufactured in an extrusion process engineered to produce materials that are said to be of high quality. The composite can be in a linear extrudate or pellet and can have a cross-section of any arbitrary shape, or can be a regular-geometric or of arbitrary-amorphous shape. The extruded material comprises a consistent proportion of polymer, wood fiber and water. During the extrusion, water is removed intentionally to dry the material to a maximum water content of less than about 10 wt-% based on the pellet weight. To make a structural unit, the pellet is introduced into an extruder apparatus wherein, under conditions of controlled mass throughput, shear, mechanical energy input, controlled temperature and pressure, the composite material is produced.

### SUMMARY OF THE INVENTION

The present invention improves the mechanical properties of natural fiber-PVC composites using PVC thermal stabilizers of high efficiency. This method is an alternative to the use of more expensive compatibilizers and complex procedures for coating the fibers.

More particularly, the present invention is directed to a process for improving mechanical and chemical properties of a composite of poly(vinyl chloride) and at least one natural fiber comprising adding to said composite at least one heat stabilizer selected from the group consisting of
A) alkyltin reverse esters-sulfides;
B) alkyltin alkyl maleates; and
C) complex mixtures of calcium and/or zinc carboxylates/acetylacetonates.

In another aspect, the present invention is directed to an article of manufacture comprising a composite of poly(vinyl chloride) and at least one natural fiber and at least one heat stabilizer selected from the group consisting of:
A) alkyltin reverse esters-sulfides;
B) alkyltin alkyl maleates; and
C) complex mixtures of calcium and/or zinc carboxylates/acetylacetonates.

### DESCRIPTION OF THE PREFERRED EMBODIMENTS

As employed herein, the term poly(vinyl chloride), or PVC, is intended to include both homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, and the like.

The term “PVC” as employed herein is also intended to include graft polymers of PVC with EVA, ABS, and MBS. Preferred substrates are also mixtures of the above-mentioned homopolymers and copolymers, in particular vinyl chloride homopolymers, with other thermoplastic and/or elastomeric polymers, in particular blends with ABS, MBS, NBR, SAN, EVA, CPE, MBAS, PMA, PMMA, EPDM, and polylactones.

Within the scope of this invention, PVC will also be understood to include recyclates of halogen-containing polymers, which are the polymers described above in more detail and which have suffered damage by processing, use or storage. PVC recyclate is particularly preferred. The recyclates may also contain minor amounts of foreign materials, typically paper, pigments, adhesives or other polymers, which are often difficult to remove. These foreign materials can also originate from contact with different substances during use or working up, for example fuel residues, paint components, metal traces, initiator residues, and water traces.

The primary requirement for the PVC material is that it retain sufficient thermoplastic properties to permit flux melt blending with wood and other natural fibers, permit formation of linear extrudate pellets, and to permit the composition material or pellet to be extruded or injection molded in a thermoplastic process forming a rigid structural member. PVC homopolymers copolymers and polymer alloys are available from a number of manufacturers including B.F. Goodrich, Vista, Air Products, Occidental Chemicals, etc. Preferred poly(vinylchloride) materials are PVC homopolymer having a molecular weight of about 10,000 to 250,000, preferably about 20,000 to 90,000.

Suitable biofibers for use in the practice of the present invention may be derived from any of a number of available sources, such as ground wood, sawdust, wood flour, ground newsprint, magazines, books, cardboard, wood pulps (mechanical, stone ground, chemical, mechanical-chemical, bleached or unbleached, sludge, waste fines), and various agricultural wastes (rice hulls, wheat, oat, barley and oat chaff, coconut shells, peanut shells, walnut shells, straw, corn husks, corn stalks, jute, hemp, bagasse, bamboo, flax, and kenaf).

Wood fiber, which is preferred because of its abundance and suitability can be derived from either soft woods or evergreens or from hard woods commonly known as broad leaf deciduous trees. Soft woods are generally preferred for fiber manufacture because the resulting fibers are longer and contain higher percentages of lignin and lower percentages of hemicellulose than hard woods. While soft wood is the primary source of fiber for use in the practice of the present invention, additional fiber make-up can be derived from a number of secondary or fiber reclaim sources, including bamboo, rice, sugar cane, flex, kenaf and recycled fibers from newspapers, boxes, computer printouts, and the like.

A preferred source for wood fiber comprises the wood fiber by-product of sawing or milling soft woods commonly known as sawdust or milling tailings. Such wood fiber has a regular reproducible shape and aspect ratio. The fibers based on a random selection of about 100 fibers are commonly at least 0.1 mm in length, at least 0.01 mm in thickness and commonly have an aspect ratio of at least 1.8. Preferably, the fibers are 0.2 to 10 mm in length, 0.02 to 1.5 mm in thickness with an aspect ratio between 2 and 7, preferably 2.5 to 6.0. The preferred fiber is derived from processes common in the manufacture of windows and doors. Wooden members are commonly ripped or sawed to size in a cross grain direction to form appropriate lengths and widths of wood materials. The by-product of such sawing operations is a substantial quantity of sawdust. In shaping a regular shaped piece of wood into a useful milled shape, wood is commonly passed through machines that selectively remove wood from the piece leaving the useful shape. Such milling operations produce substantial quantities of sawdust or mill tailing by-products. Lastly, when shaped materials are cut to size and mitered joints, butt joints, overlapping joints, mortise and tenon joints are manufactured from pre-shaped wooden members, substantial waste trim is produced. Such large trim pieces are commonly cut and machined to convert the larger objects into wood fiber having dimensions approximating sawdust or mill tailing dimensions. The wood fiber sources can be blended regardless of particle size and used to make the composite. The fiber stream can be pre-sized to a preferred range or can be sized after blending. Further, the fiber can be pre-pelletized before use in composite manufacture.

The poly(vinylchloride) and wood fiber can be combined and formed into pellets using, for example, thermoplastic extrusion processes, and the wood fiber can be introduced into the pellet making process in a number of sizes. Preferably, the wood fiber should have a minimum size of length and width of at least about 1 mm because wood flour tends to be explosive at certain wood to air ratios. Further, wood fiber of appropriate size of an aspect ratio greater than 1 tends to increase the physical properties of the extruded structural member. However, useful structural members can be made with fibers of very large size. Fibers that are up to 3 cm in length and 0.5 cm in thickness can be used as input to the pellet or linear extrudate manufacture process. However, particles of this size do not produce the highest quality structural members or maximized structural strength. The best appearing products with maximized structural properties are manufactured within a range of particle sizes as set forth below. Further, large particle wood fibers can be reduced in size by grinding or other similar processes that produce a fiber similar to sawdust having the stated dimensions and aspect ratio. One further advantage of manufacturing sawdust of the desired size is that the material can be pre-dried before introduction into the pellet or linear extrudate manufacturing process. Further, the wood fiber can be pre-pelletized into pellets of wood fiber with small amounts of binder if necessary.

During the pelletizing process for the composite pellet, the PVC and wood fiber are intimately contacted at high temperatures and pressures to ensure that the wood fiber and polymeric material are wetted, mixed, and extruded in a form such that the polymer material, on a microscopic basis, coats and flows into the pores, cavities, etc., of the fibers. The fibers are preferably substantially oriented by the extrusion process in the extrusion direction. Such substantial orientation causes the overlapping of adjacent parallel fibers and the polymeric coating of the oriented fibers, resulting in a material useful for the manufacture of improved structural members having improved physical properties. The degree of orientation is typically about 20%, preferably 30% above random orientation, which is about 45 to 50%, said orientation being percents above the normal orientation.

Moisture control is an important element of manufacturing a useful linear extrudate or pellets. Depending on the equipment used and processing conditions, control of the water content of the linear extrudate or pellet can be important in forming a successful structural member substantially free of internal voids or surface blemishes. The concentration of water present in the sawdust during the formation of pellets or linear extrudate when heated can flash from the surface of a newly extruded structural member and can come as a result of a rapid volatilization, form a steam bubble deep in the interior of the extruded member that can pass from the interior through the hot thermoplastic extrudate leaving a substantial flaw. In a similar fashion, surface water can bubble and leave cracks, bubbles, or other surface flaws in the extruded member.

Trees when cut, depending on relative humidity and season, can contain from 30 to 300 weight percent water based on fiber content. After rough cutting and finishing into sized lumber, seasoned wood can have a water content of from 20 to 30 weight percent based on fiber content. Kiln dried sized lumber cut to length can have a water content typically in the range of 8 to 12%, commonly 8 to 10 weight percent based on fiber. Some wood sources, such as poplar or aspen, can have increased moisture content while some hard woods can have reduced water content.

Because of the variation in water content of wood fiber sources and the sensitivity of extrudate to water content, control of water to a level of less than 8 weight percent in the pellet based on pellet weight can be important. When structural members are extruded in a non-vented extrusion process, the pellet should be as dry as possible and have a water content between about 0.01 and about 5 weight %, preferably less than 1 weight %. When using vented equipment in manufacturing the extruded linear member, a water content of less than about 8 weight % can be tolerated if processing conditions are such that the vented extrusion equipment can dry the thermoplastic material prior to the final formation of the structural member at the extrusion head. The pellets or linear extrudate of the invention can be made by extrusion of the PVC and wood fiber composite through an extrusion die resulting in a linear extrudate that can be cut into a pellet shape. The pellet cross-section can be any arbitrary shape depending on the extrusion die geometry.

Within the scope of the present invention are the following types of stabilizers:

1. Alkyltin reverse esters-sulfides (Ex: Stabilizer B) that are complex mixtures of compounds with the general formula: 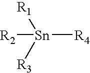
wherein:
R₁ is alkyl, preferably of from 1 to 15 carbon atoms;
R₂ and R₃ are independently selected from the group consisting of moieties of the structure
   —S—(CH₂)ₙ—OCOR′
   where n=1 to 10 and R′ is alkyl, preferably of from 1 to 15 carbon atoms, or aryl, preferably of from 6 to 14 carbon atoms;
R₄ is selected from the group consisting of alkyl, preferably of from 1 to 15 carbon atoms and —S—(CH₂)ₙ—OCOR′ where n=1 to 10 and R′ is an alkyl, preferably of from 1 to 15 carbon atoms, or aryl, preferably of from 6 to 14 carbon atoms; and 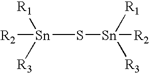
   wherein R₁, R₂, and R₃ are as defined above.

2. Alkyltin alkyl maleates (Ex: Stabilizer C), which are a complex mixture of compounds with the general formula: 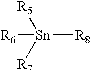
where
R₅ is alkyl, preferably of from 1 to 15 carbon atoms;
R₆ and R₇ are independently selected from the group consisting of moieties of the structure
   —OOC—CH═CH—COOR′
   where R′ is an alkyl, preferably of from 1 to 15 carbon atoms, or aryl, preferably of from 6 to 14 carbon atoms;
R₈ is alkyl, preferably of from 1 to 15 carbon atoms, or —OOC—CH═CH—COOR′ where R′ is an alkyl, preferably of from 1 to 15 carbon atoms, or aryl, preferably of from 6 to 14 carbon atoms.

3. complex mixtures of calcium and/or zinc carboxylates/acetylacetonates (Example D), with the general formulas: 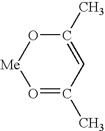
where Me is calcium (Ca), barium (Ba), magnesium (Mg), strontium (Sr) or zinc (Zn) and
Me(OOC—R)₂
where Me is (Ca), barium (Ba), magnesium (Mg), strontium (Sr), or zinc (Zn) and R is an alkyl, preferably of from 1 to 25 carbon atoms, or aryl, preferably of from 6 to 14 carbon atoms.

The following stabilizers were used in the examples presented below:
Stabilizer A: mixture of mono-methyltin and dimethyltin (2-ethylhexyl thioglycolates)—(Mark-1900) used as control and an example of the prior art.
Stabilizer B: methyltin mercaptide/sulfide (Mark 1993)
Stabilizer C: dibutyltin maleate (Mark 2289)
Stabilizer D: Ca/Zn stabilizer based on zinc acetylacetonate.

Depending on their end use requirement, the compositions employed in the practice of the present invention can also contain further additives and stabilizers, typically potassium, sodium, calcium, magnesium, and barium soaps or other tin derivatives, as well as, inter alia, plasticisers, epoxide compounds, metal perchlorates, lubricants, fillers, reinforcing agents, antioxidants, polyols, dawsonites, hydrotalcites, organic phosphites, 1,3-diketo compounds, mono-, oligo- or polymeric dihydropyridines, sterically hindered amines (HALS), light stabilisers, UV absorbers, lubricants, fatty acid esters, paraffins, blowing agents, fluorescent whitening agents, pigments, flame retardants, antistatic agents, aminocrotonates, thiophosphates, gelling assistants, metal deactivators, peroxide scavenging compounds, modifiers and further sequestrants for Lewis acids, and the like, all as described in detail in U.S. Pat. No. 6,531,533 the disclosure of which is incorporated herein by reference in its entirety.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

The formulations used are presented in Table 1.

TABLE 1
Formulations for Wood-PVC Composites

| | Stabilizer A | | Stabilizer B | Stabilizer C | Stabilizer D | |
|---|---|---|---|---|---|---|
| Material | Mark 1900 | | Mark 1993 | Mark 2289 | TS 1147 | |
| PVC Oxy185F | 100 | 100 | 100 | 100 | 100 | 100 |
| PA 40 | 5.0 | 5.0 | 5.0 | 5.0 | 5.0 | 5.0 |
| PA 101 | 1.0 | 1.0 | 1.0 | 1.0 | 1.0 | 1.0 |
| CPE 3615P | 5.0 | 5.0 | 5.0 | 5.0 | 5.0 | 5.0 |
| Ca Stearate | 1.2 | 1.2 | 1.2 | 0 | 0 | 0.57 |
| Paraffin Wax | 0.8 | 0.8 | 0.8 | 0.5 | 0.6 | 0.6 |
| Marklube | 0.5 | 0.5 | 0.5 | 0 | 0.5 | 0.5 |
| L-106 | | | | | | |
| AC 629A | 0.2 | 0.2 | 0.2 | 0 | 0.2 | 0.2 |
| Stabilizer | 1.5 | 2.5 | 1.5 | 4.0 | 3.0 | 1.5 |
| Wood (%) | 40 | 40 | 40 | 40 | 40 | 40 |

PVC Oxy 185F is a suspension PVC resin from OxyVinyl with K = 56.
PA-40 and PA101 are acrylic impact modifiers from Kanaka.
CPE-361P is an acrylic impact modifier from Dow.
AC 629A is an oxidized polyethylene lubricant from Honeywell.
Marklube L-106 is a lubricant from Crompton Corporation.

The composite extrudates were obtained as follows: All the components of the PVC formulation except wood were placed in a Papenineier mixer and mixed for 5 minutes at the low setting and 10 minutes at the high setting. The temperature increased from 25 to 50° C. Wood flour Standard Softwood Grade 4020 from American Wood Fiber Corp. was dried in an oven at 80° C. for 24 hours to reduce the content of water from 10% to 1-2%. PVC compounds with 40% by weight wood flour were mixed on a roller mixer for 1 hour. The resulting compound was extruded using a Rheomex TW-100 Haake Buchler conical counter-rotating twin-screw extruder with a screw diameter of ¾ inch. The extruder was starve fed using a volumetric K-Tron K2VT20 twin screw feeder with 8-34 g/min compound depending of the type of formulation. The extruder had three zones at temperatures of 180-190° C. The die was 2″×⅛″ and was heated at 190° C.

Strips of 33 cm×2 cm×0.3 cm were cut from the extrudate and introduced into a Mathis oven at 204° C. The strips were removed from the oven at a rate of 20 mm every 2 minutes. The discoloration resulting from thermal degradation was computer scanned using the Fluoscan program (Dr. Stapfer, Dusseldorf) and the L*, a*, and b* values were calculated according to ASTM D2244 1993 as average value for a surface of 20×20 mm. From those values the total color change was calculated using the formula:
ΔE*=(ΔL*²+Δa*²+Δb*²)^{1/2}

The value of ΔE* increases linearly as a function of time and the slope of this line was defined as the rate of degradation and presented in table 2.

Tensile test specimens of 6½″×¾″×⅛″ according to ASTM D638 were cut from the extrudate strips and the stress at break and Young modulus were measured using a Series IX Automated Materials Testing Systems, Instron Corporation (Table 2).

Samples of 105 mm×12 mm×3 mm were cut from an extrudate and heat deflection temperature was measured according to ASTM D648 using a HDV 03 (Dynisco) instrument at a weight of 264 psi and a temperature increase rate of 2° C./min (Table 2)

Limiting Oxygen Index (LOI) was measured according to ISO 4589, ASTM D2863 with an Oxygen Index (Fire Testing Technology) instrument on samples of 115 mm×6 mm×3 mm cut from extrudate (Table 2)

TABLE 2
Extrudate properties as a function of stabilizer type and concentration

| | Con- | Rate of | Young's | Load at | | |
|---|---|---|---|---|---|---|
| | centration | PVC | Modulus | break | LOI | HDT |
| Stabilizer | (phr) | degradation | psi | (psi) | % O₂ | (° C.) |
| A | 1.5 | 1.343 | 123400 | 2070 | 25.7 | 63.8 |
| B | 1.5 | 1.423 | 119600 | 2130 | 25.5 | |
| C | 4 | 0.687 | 190652 | 4017 | 28.1 | 70.6 |
| D | 3 | 1.672 | 134300 | 2534 | 27.3 | 70.4 |
| D | 1.5 | 1.207 | 106700 | 2289 | 26.7 | 68.3 |

The data show that the mechanical properties of the composites are dependent on the thermal stability of the PVC. In order to obtain composites of good mechanical properties, high efficiency PVC stabilizer formulations should be used.

In view of the many changes and modifications that can be made without departing from principles underlying the invention, reference should be made to the appended claims for an understanding of the scope of the protection afforded the invention.

1. A process for improving mechanical and chemical properties of a composite of poly(vinyl chloride) and at least one natural fiber comprising adding to said composite at least one heat stabilizer selected from the group consisting of:
A) alkyltin reverse esters-sulfides;
B) alkyltin alkyl maleates; and
C) complex mixtures of calcium and/or zinc carboxylates/acetylacetonates.

2. The process of claim 1 wherein the natural fiber is wood fiber.

3. The process of claim 2 wherein the heat stabilizer is an alkyltin reverse esters-sulfide.

4. The process of claim 3 wherein the heat stabilizer is a complex mixture of compounds with the general formula: 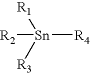
wherein:
R₁ is alkyl;
R₂ and R₃ are independently selected from the group consisting of moieties of the structure:
—S—(CH₂)ₙ—OCOR′
where n=1 to 10 and R′ is alkyl;
R₄ is selected from the group consisting of alkyl and —S—(CH₂)ₙ—OCOR′ where n=1 to 10 and R′ is alkyl or aryl, and 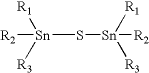
wherein R₁, R₂, and R₃ are as defined above.

5. The process of claim 2 wherein the heat stabilizer is an alkyltin alkyl maleate.

6. The process of claim 5 wherein the heat stabilizer is a complex mixture of compounds of the general formula: 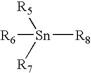
where
R₅ is alkyl;
R₆ and R₇ are independently selected from the group consisting of moieties of the structure
—OOC—CH═CH—COOR′
where R′ is an alkyl or aryl; and
R₈ is alkyl or —OOC—CH═CH—COOR′ where R′ is alkyl or aryl.

7. The process of claim 2 wherein the heat stabilizer is complex mixtures of calcium and/or zinc carboxylates/acetylacetonates.

8. The process of claim 7 wherein the heat stabilizer is a complex mixture of calcium and/or zinc carboxylates/acetylacetonates with the general formulas: 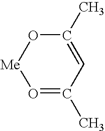
where Me is calcium, barium, magnesium, strontium, or zinc, and
Me(OOC—R)₂
where Me is Calcium, barium, magnesium, strontium, or zinc, and
R is alkyl or aryl.

9. An article of manufacture comprising a composite of poly(vinyl chloride) and at least one natural fiber and at least one heat stabilizer selected from the group consisting of:
A) alkyltin reverse esters-sulfides that are a complex mixture of compounds with the general formula: 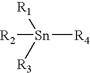
wherein:
R₁ is alkyl;
R₂ and R₃ are independently selected from the group consisting of moieties of the structure
—S—(CH₂)ₙ—OCOR′
where n=1 to 10 and R′ is alkyl
R₄ is selected from the group consisting of alkyl and —S—(CH₂)ₙ—OCOR′ where n=1 to 10 and R′ is alkyl or aryl; and 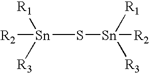
wherein R₁, R₂, and R₃ are as defined above;
B) alkyltin alkyl maleates that are a complex mixture of compounds of the general formula: 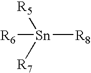
where
R₅ is alkyl;
R₆ and R₇ are independently selected from the group consisting of moieties of the structure
—OOC—CH═CH—COOR′
where R′ is an alkyl or aryl; and
R₈ is alkyl or —OOC—CH═CH—COOR′ where R′ is alkyl or aryl; and
C) complex mixtures of calcium and/or zinc carboxylates/acetylacetonates with the general formulas: 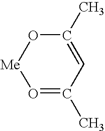
where Me is calcium, barium, magnesium, strontium, or zinc, and
Me(OOC—R)₂
where Me is calcium, barium, magnesium, strontium, or zinc, and
R is alkyl or aryl.

10. The article of claim 9 wherein the natural fiber is wood fiber.

11. (canceled)

12. The article of claim 10 wherein the heat stabilizer is a complex mixture of compounds with the general formula: 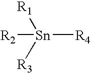
wherein:
R₁ is alkyl of from 1 to 15 carbon atoms;
R₂ and R₃ are independently selected from the group consisting of moieties of the structure
—S—(CH₂)ₙ—OCOR′
where n=1 to 10 and R′ is alkyl of from 1 to 15 carbon atoms or aryl of from 6 to 14 carbon atoms;
R₄ is selected from the group consisting of alkyl of from 1 to 15 carbon atoms and —S—(CH₂)ₙ—OCOR′ where n=1 to 10 and R′ is alkyl of from 1 to 15 carbon atoms or aryl of from 6 to 14 carbon atoms; and 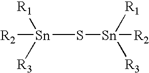
wherein R₁, R₂, and R₃ are as defined above.

13. (canceled)

14. The article of claim 10 wherein the heat stabilizer is a complex mixture of compounds of the general formula: 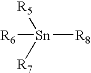
where
R₅ is alkyl of from 1 to 15 carbon atoms;
R₆ and R₇ are independently selected from the group consisting of moieties of the structure
—OOC—CH═CH—COOR′
where R′ is an alkyl of from 1 to 15 carbon atoms or aryl of from 6 to 14 carbon atoms; and
R₈ is alkyl of from 1 to 15 carbon atoms or —OOC—CH═CH—COOR′ where R′ is alkyl of from 1 to 15 carbon atoms or aryl of from 6 to 14 carbon atoms.

15. (canceled)

16. The article of claim 10 wherein the heat stabilizer is a complex mixture of calcium and/or zinc carboxylates/acetylacetonates with the general formulas: 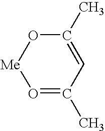
where Me is calcium, barium, magnesium, strontium, or zinc, and
Me(OOC—R)₂
where Me is calcium, barium, magnesium, strontium, or zinc, and
R is alkyl of from 1 to 25 carbon atoms or aryl of from 6 to 14 carbon atoms.

17. The article of claim 12 wherein the heat stabilizer is methyltin mercaptide/sulfide.

18. The article of claim 14 wherein the heat stabilizer is dibutyltin maleate.

19. The article of claim 16 wherein the heat stabilizer is a Ca/Zn stabilizer based on zinc acetylacetonate.
